(19) United States
(12) Patent Application Publication
(10) Pub. No.: US 2018/0217104 A1
(43) Pub. Date: Aug. 2, 2018

(54) NONDESTRUCTIVE DETERMINATION OF TOUGHNESS OF METAL, PLASTIC, AND COMPOSITE MATERIALS

(71) Applicant: Fluor Technologies Corporation, Sugar Land, TX (US)

(72) Inventor: Barry Messer, Calgary (CA)

(21) Appl. No.: 15/746,774

(22) PCT Filed: Jul. 22, 2016
(86) PCT No.: PCT/US2016/043670

§ 371 Date: Jan. 22, 2018

Related U.S. Application Data
(60) Provisional application No. 62/195,687, filed on Jul. 22, 2015.

(51) Int. Cl. G01N 29/06; G01N 29/44

(52) U.S. Cl. CPC G01N 29/0681; G01N 2291/02827; G01N 2291/0234; G01N 29/4427

(57) ABSTRACT

Embodiments relate generally to systems and methods for determining a toughness value for a material of a metal part, wherein the method comprises detecting a texture of a carbon steel material using an ultrasonic microscopy unit, wherein the ultrasonic microscopy unit uses one or more waveforms including at least one of straight beam, phased array, shear wave, and time-of-flight diffraction (TOFD); determining elemental analysis of the carbon steel material; combining the texture with the elemental analysis to generate a toughness value for the steel; comparing the generated toughness value with a standard curve, wherein when the toughness value falls below the curve, the carbon steel material comprises an acceptable toughness, and when the toughness value falls above the curve, the carbon steel material comprises an unacceptable toughness.

### CROSS-REFERENCE TO RELATED APPLICATIONS

The present application claims priority to U.S. Provisional Patent Application No. 62/195,687 filed Jul. 22, 2015 by Barry Raymond Messer and entitled “Nondestructive Determination of Toughness of Metal, Plastic and Composite Materials,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The background description includes information that may be useful in understanding the present invention. It is not an admission that any of the information provided herein is prior art or relevant to the presently claimed invention, or that any publication specifically or implicitly referenced is prior art.

Materials used in pipes, buildings, piping, pumps, exchangers, bridges, and other structures is prone to cracking and loss of structural integrity on mechanical stress, particularly at low temperatures. Such loss of structural integrity can occur due to ductile failure (i.e. deformation followed by loss of integrity) or brittle failure (i.e. loss of structural integrity without deformation). As such, an accurate assessment or prediction of the toughness of such materials is necessary. Such testing is generally carried out in a destructive (for example, as described in ASTM E23 “Standard Test Methods for Notched Bar Impact Testing of Metallic Materials”) manner. In some jurisdictions, however, current standards and practices do not require destructive testing of such materials and items, which can be costly.

### SUMMARY

In an embodiment, a method for determining a toughness value for a material of a metal part comprises detecting a texture of a carbon steel material using an ultrasonic microscopy unit, wherein the ultrasonic microscopy unit uses one or more waveforms including at least one of straight beam, phased array, shear wave, and time-of-flight diffraction (TOFD); determining elemental analysis of the carbon steel material; combining the texture with the elemental analysis to generate a toughness value for the steel; comparing the generated toughness value with a standard curve, wherein when the toughness value falls below the curve, the carbon steel material comprises an acceptable toughness, and when the toughness value falls above the curve, the carbon steel material comprises an unacceptable toughness.

In an embodiment, a method for determination of toughness of a material comprises obtaining a measure of texture within a volume of the material, wherein the obtaining is performed in a nondestructive manner; obtaining an elemental composition of the material; integrating the measure of texture and the elemental composition to generate a toughness value; and comparing the toughness value to a standard value or standard value set.

In an embodiment, a system for non-destructive determination of material toughness comprises an ultrasonic testing unit, configured to generate first data related to texture within a volume of a material; an elemental analysis unit, configured to generate second data related to the elemental composition of the material; and a processor that is communicatively coupled to the ultrasonic testing unit and to the elemental analysis unit, wherein the processor is configured to combine the data to provide a toughness value.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a graph showing the effect of grain size on the impact load, according to an embodiment of the disclosure.

FIG. 2 illustrates a graph showing an exemplary standard curve for toughness value, according to an embodiment of the disclosure.

FIG. 3 illustrates a plurality of signals generated by ultrasonic testing of three different pipes, where the pipes are formed of carbon steel material.

FIG. 4 illustrates a plurality of signals generated by ultrasonic testing of two different flanges, where the flanges are formed of carbon steel material.

FIG. 5 illustrates a plurality of signals generated by ultrasonic testing of two different T-joints, where the T-joints are formed of carbon steel material.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Destructive testing provides definitive information on material toughness, but has a number of shortcomings beyond the direct commercial impact of the loss of tested materials. For example, for many materials toughness is a function of temperature. As a result, in order to provide an accurate assessment of material performance destructive testing should be carried out over a range of temperature conditions that reflect the operating conditions of the manufactured items. In addition, Joo et al. (“Experiments to Separate the Effect of Texture on Anisotropy of Pipeline Steel” Materials Science and Engineering A556 (2012): 601-606) shows, using a destructive method, that material texture (which is, at least in part, a function of distribution and orientation of the granular or polymeric structure within a material) introduces directionally dependent (i.e. anisotropic) effects on material resistance to impact stress. As a result, destructive tests (for example, notched bar impact testing) should be carried out repeatedly at different orientations and across a range of temperatures in order to provide an accurate assessment of material toughness. All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Non-destructive examination has been shown to be useful in identifying where there are existing cracks or discontinuities in such materials. Ultrasonic testing is commonly used to characterize the internal structure of various materials. For example, United States Patent Application Publication No. 2014/0060193 (to Zhu et al.) discusses methods in which a high-amplitude acoustic source is used for ultrasonic testing of such materials and even of structures in hostile environments is disclosed. While this application discusses detection of variations in structure, the presence of cracks and other discontinuities, and characterization of material thickness, it does not provide an estimate of the toughness or similar qualities of tested materials.

U.S. Pat. No. 8,596,127 (to Falter et al.) discusses systems and methods for processing of ultrasonic signals utilized in material characterization that provide for dynamic adjustment of focus and aperture at different depths within the tested material, which is achieved using a complex array of numerous transmitting and receiving elements. Similarly, U.S. Pat. No. 8,776,603 (to Inoue) discusses methods for non-destructive testing that utilize a single-pulse ultrasonic wave signal. As noted above, however, such systems and methods are limited to characterization of current flaws, cracks, and discontinuities of the material being characterized and do not provide useful information regarding toughness (or similar factors) that are predictive of the development of such flaws.

Thus, there is still a need for non-destructive testing systems and methods that provide a predictive estimate of quality of the material (for example, material toughness).

The inventive subject matter provides apparatus, systems and methods that provide nondestructive characterization of the toughness (i.e. resistance to impact load and/or brittle failure) of various items and fixtures, for example piping, fittings, flanges, plate, tankage, pressure vessels, and castings. Such items and fixtures can be made from metal, plastic and other polymeric materials, and/or a composite material that shows either a pattern of grains or ordered/structured polymerization. Systems and methods of the inventive concept utilize qualitative texture data that are integrated or otherwise combined with elemental composition data to provide a value that is predictive of the material's toughness. This characterization can be carried out in situ, and while installed materials are in use (i.e. while pressurized, at elevated temperatures, while coated, and while directing flow). In preferred embodiments of the inventive concept, the material is steel, which can be manufactured from virgin materials or can include recycled content.

Various objects, features, aspects and advantages of the inventive subject matter will become more apparent from the following detailed description of preferred embodiments, along with the accompanying drawing figures in which like numerals represent like components.

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, Advanced Encryption Standard (AES), public-private key exchanges, web service application programming interfaces (APIs), known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including proving accurate determination of material toughness in a non-destructive manner, particularly where assessment of grain size or polymer distribution is non-predictive. Furthermore, methods of the inventive concept can be applied to materials that are currently installed and in use, and that such testing can be performed at ambient temperatures while remaining predictive of material performance over a broad range of temperatures.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

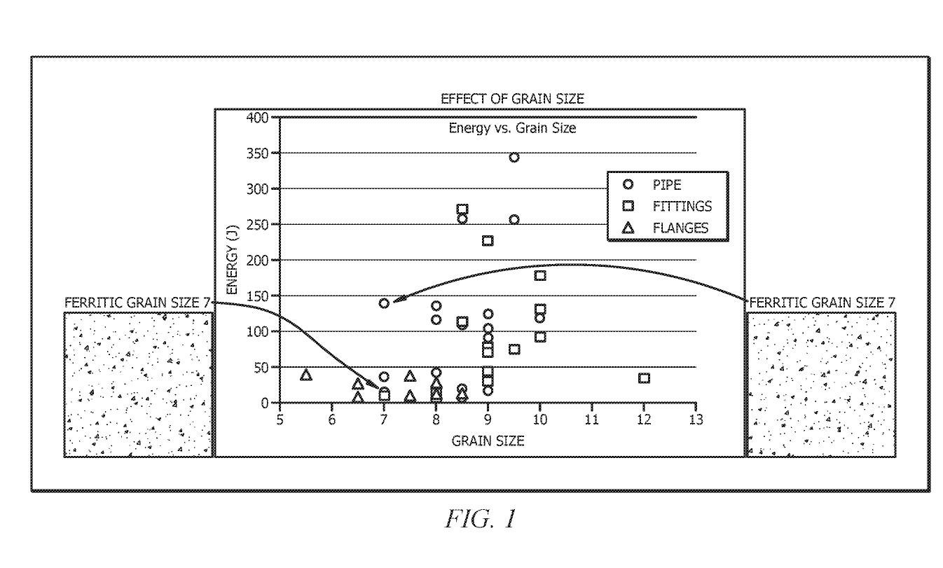

In conventional practice toughness in steels is essentially universally believed to be an exclusive and direct function of the grain size of the metal, with smaller grain sizes being associated with greater resistance to impact load. Surprisingly, the inventors have found that grain size is not predictive of brittle failure (as shown by impact testing) for many materials. This effect can be more pronounced at low (i.e. less than 0° C.) temperatures. Results of a set of experiments using steel with a high recycled steel content are shown in FIG. 1.

Referring now to FIG. 1, testing results are shown for an impact load (in Joules) for various lots of steel with high recycled steel content. As shown in FIG. 1, there is no apparent relationship between grain size and toughness as steels with apparently identical grain sizes (ferritic grain size 7) can have widely varying resistance to impact load (from nearly 200 Joules to less than 20 Joules). This can have a significant impact on the quality of items manufactured from such materials, particularly in jurisdictions that do not require destructive impact testing of steels to determine toughness (for example, the United States), as such items can pass current standards while potentially exhibiting low toughness. While destructive testing or items manufactured using such materials can be implemented in such jurisdictions, such testing is highly undesirable from an economic standpoint.

The inventors have found that toughness in metal (such as steels), plastics and other polymeric materials, and composite materials can be accurately assessed in a nondestructive manner. This can be accomplished by combining data related to material texture with data related to the elemental composition of the material to generate a toughness value. This value can be compared to a standard value, curve, or multidimensional surface/volume generated using impact load resistance data from known samples in order to provide an accurate prediction of the impact load resistance of the test material.

It should be appreciated that texture is a function of size, shape, orientation, spacing, and distribution of grains (for example, in a metal) or ordered polymerized regions (for example, in a plastic) within the material. As such it is distinct and different from a simple measurement of grain size. In embodiments of the inventive concept, texture is determined through a volume of the material to be tested (as opposed to a surface characterization). Texture, therefore, can be characterized through a depth of 1 mm, 2 mm, 5 mm, 10 mm, 20 mm, 50 mm, 100 mm, 200 mm, or more through an area of material being tested. In some embodiments, texture is determined starting at an external surface and extending through the entire thickness of an item made of the material being characterized.

Texture can be characterized using any suitable nondestructive tool and/or technique. Suitable tools and/or techniques include X-ray diffraction, electron backscatter diffraction, neutron diffraction, synchrotron diffraction, ultrasound examination, and three-dimensional acoustic or ultrasonic microscopy. Such methods are selected to provide sufficient spatial resolution and depth of penetration to accurately assess texture within the desired volume. In some embodiments of the inventive concept, more than one method can be used to assess texture. While texture can be the result of a number of independent factors, in preferred embodiments of the inventive concept texture is expressed as a single aggregate value (i.e. a texture value), which can be unitless.

Texture can be characterized from a sample provided by a vendor for testing, from samples produced during manufacturing (for example, from waste generated during milling or cutting operations), or from a finished item. In some embodiments, such a sample can measure approximately 5 cm by 15 cm. It should be appreciated however that texture can be impacted by manufacturing processes, for example extrusion, forging, rolling, and heat treatment. As a result, in preferred embodiments of the inventive concept texture values are obtained from a finished item. In some embodiments, reference or standard texture values can be obtained from analogous items or from material samples that have undergone similar manufacturing steps and have known toughness values (for example, toughness values obtained by destructive testing at various temperatures).

In embodiments of the inventive concept, the texture value is utilized in combination with the results of elemental analysis. Such elemental analysis can, for example, be performed on samples provided by a vendor for test purposes, from samples obtained during manufacturing (for example, shavings obtained during drilling or milling operations), or taken directly from a finished item. Since elemental composition is not significantly impacted by most manufacturing processes, in embodiments of the inventive concept elemental analysis data can be obtained from fished items or from samples. Elemental analysis can be performed by any suitable method, including optical emission spectroscopy, inductively coupled plasma analysis, atomic absorption analysis, X-ray fluorescence analysis, proton induced X-ray emission, and chemical analysis. While elemental analysis of samples can be carried out in either a destructive or non-destructive fashion, elemental analysis of finished items is preferably carried out using a non-destructive method. When methods of the inventive concept are applied to steel, elemental analysis can be directed to the following elements: B, Ta, Se, Cu, Ni, Cr, Mo, P, Nb, V, Mn, C, S, As, Sb, Pb, W, Ti and/or Al. In preferred embodiments, the Mn, C, and/or B content of the steel can be characterized. Elemental composition can be expressed as an element composition value. This can be expressed as a concentration or percentage (by weight or volume) of a designated element. Alternatively, an element composition value can be expressed as a ratio between the concentrations of two or more elements.

In methods of the inventive concept the texture value and the element composition value are combined, aggregated, and/or integrated to give a toughness value. Such a toughness value can be derived mathematically or empirically. For example, texture values and elemental composition values for material or item samples having a range of physically characterized toughness values can be used to generate a dataset that represents a toughness space. Such functions can be represented by a curvilinear relationship, two dimensional surface, or multidimensional volume. A cutoff or acceptance criteria value (or set of values) that provides an indication of texture and elemental composition combinations that provide acceptable toughness can be expressed as a curvilinear line, surface, or volume within such a toughness space. There are a wide range of commercial data analysis tools suitable for performing such calculations. Such a toughness space can be modeled mathematically, and once generated such a mathematical model can be applied to texture and elemental composition obtained from a material sample or finished item to be tested in order to generate an estimated toughness value. This estimated toughness value can then be compared to performance requirements. Alternatively, texture value and elemental analysis value data from material samples having a range of physically characterized toughness values can be used to generate a graphical representation of toughness values relative to these factors. The texture value and elemental composition value of a test item or sample can then be marked or otherwise indicated on such a representation and the toughness value estimated visually. In either mathematical modeling or graphical representation, toughness value limits can be represented by a standard value or set of standard values to aid in assessing acceptability of a test item or sample.

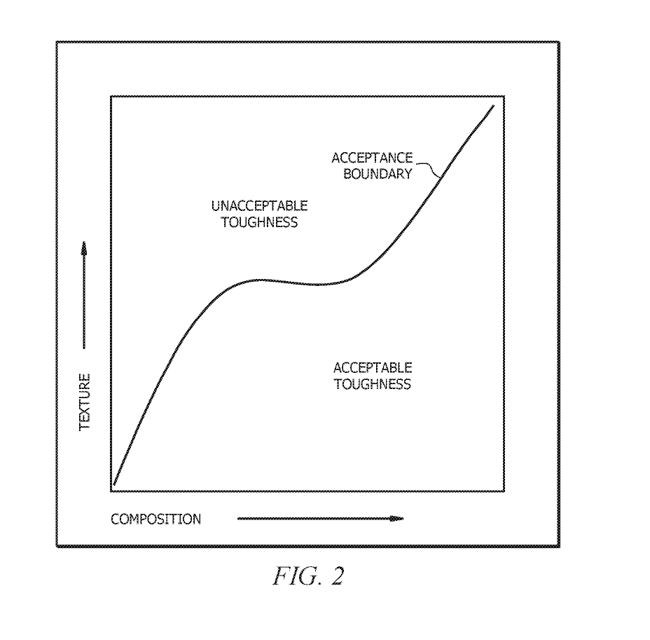

FIG. 2 depicts a cross section of a three dimensional model, with a two dimensional space representing unacceptable and acceptable toughness values across a range of combined texture and composition values. The cutoff between unacceptable and acceptable combined values presents as a curvilinear line within this toughness space. It should be appreciated that additional variables (for example, composition data related to a different element, temperature, measurement angle, etc.) can be represented as additional dimensions in such a relationship, in which case the cutoff delineation can be represented as a surface, three dimensional volume, or higher order volume.

It should be appreciated that different items manufactured from the same lot of material can be characterized using different reference data sets in order to accommodate the effects of different manufacturing methods. For example, a metal item manufactured by extrusion and heating to a relatively low temperature can be evaluated using a different data set from that used to evaluate a metal item manufactured by forging and exposure to high temperatures. Manufacturing methods such as extrusion, rolling, stamping, hammering (i.e. wrought items), and/or forging may require the use of different data sets associated with their respective manufacturing methods. Similarly, a single finished item can be characterized using different data sets for different portions of the item, where such different data sets correlate with one or more manufacturing methods applied to the respective portion of the item.

Since both texture evaluation and elemental analysis can be performed in a non-destructive manner, it should be appreciated that methods of the inventive concept can be performed on finished parts. In preferred embodiments, methods of the inventive concept can advantageously be performed on finished items that have been installed (i.e. in situ) and/or on finished and installed items that are currently in use (for example, piping directing a flow of liquid, gas, or suspended solids; painted or coated items; pressurized vessels; at least partially filled tanks or vessels, etc.).

Another embodiment of the inventive concept is a system for characterizing toughness in materials or finished items in a nondestructive fashion. Such a system can include a unit for characterizing texture within a volume of material, and can utilize one or more of the testing methods noted above. Such a system can also include an elemental analysis unit. In preferred embodiments such an elemental analysis unit can perform an elemental analysis operation as described above in a non-destructive manner. Both the texture characterization unit and the elemental analysis unit are in direct or indirect communication with a processor (for example, a computer, smart device, and/or dedicated processor). Such a processor can perform data analysis functions and also provide a user interface and control functions for operation of the texture characterization and elemental analysis units. Such a processor can also include or be in communication with a database that includes historical data related to texture, elemental composition, and/or toughness, for example data derived from control or standard material samples. In some embodiments such data can be in the form of one or more mathematical models derived from physical data. In such an embodiment, the processor can also combine or otherwise integrate texture and elemental composition data from a test item or material sample and access such historical data to derive an estimate of the toughness of the test item or material sample. Such an estimate can be reported to a user directly via the user interface or, alternatively, be transmitted (for example, via email) to a remote location.

In preferred embodiments of a system of the inventive concept, the system is incorporated into a single unit that is readily transportable, and that is dimensioned and otherwise configured to facilitate application to typical fixtures (for example, piping, fittings, flanges, plate, tanks, and/or pressure vessels) in the field. Towards that end, a system of the inventive concept can include additional functional components, such as a portable power supply, mounting device, and/or wireless communication device.

While reference is made to the use of methods and systems of the inventive concept with steel, it should be appreciated that methods and systems of the inventive concept can be applied to any metal or alloy, particularly metals utilized for structural and purposes in which the metal is likely to be exposed to impact or sudden stress below a transition temperature. Typical metals that can be characterized in this fashion include cast and/or wrought iron, carbon steels, low alloy steels, high alloy steels, ferritic steels, martensitic steels, austenitic steels, duplex steels, aluminum, magnesium, and tungsten.

In an example, the non-destructive testing may comprise the use of ultrasonic testing to determine “texture” which indicates grain size and/or grain size distribution. The texture information may be determined using one or more ultrasonic waveforms, which may include straight beam, phased array, shear wave, time-of-flight diffraction (TOFD), or any other known waveforms or combinations of waveforms.

Once the texture information is determined, it may be combined with elemental composition data, such as the carbon (C) content, the Manganese (Mn) content, a C-Mn ratio, and/or other composition data. Combining this information may generate a toughness value for the material, which may be compared to a toughness standard.

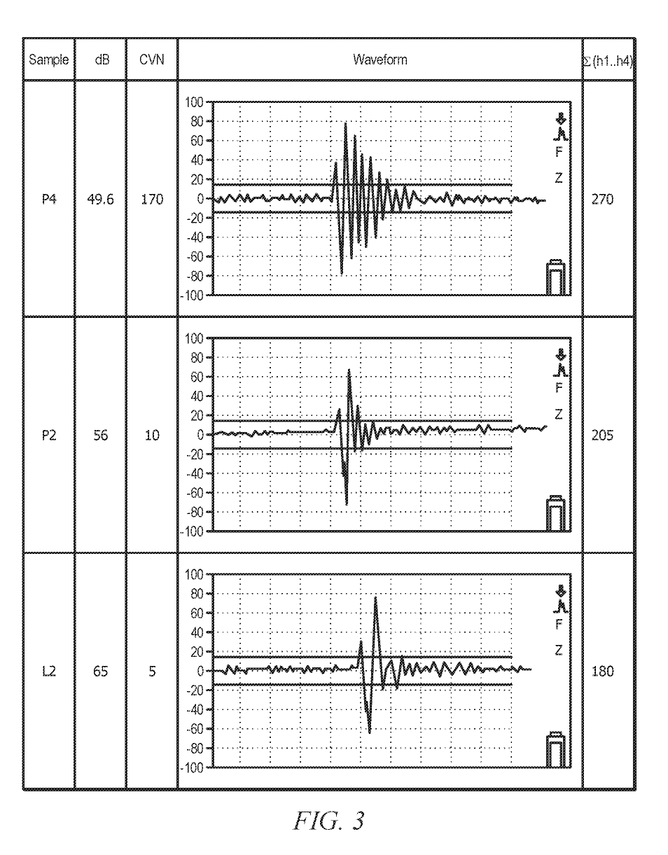

The toughness standard may be defined by correlations between the results of non-destructive testing (ultrasonic testing) and the results of impact testing of the same materials. The results of exemplary testing performed on different metal parts are shown in FIGS. 3-5. These test results may be correlated to Charpy V-notch (CVN) test results of the same parts.

FIG. 3 illustrates a plurality of signals generated by ultrasonic testing of three different pipes, where the pipes are formed of carbon steel material.

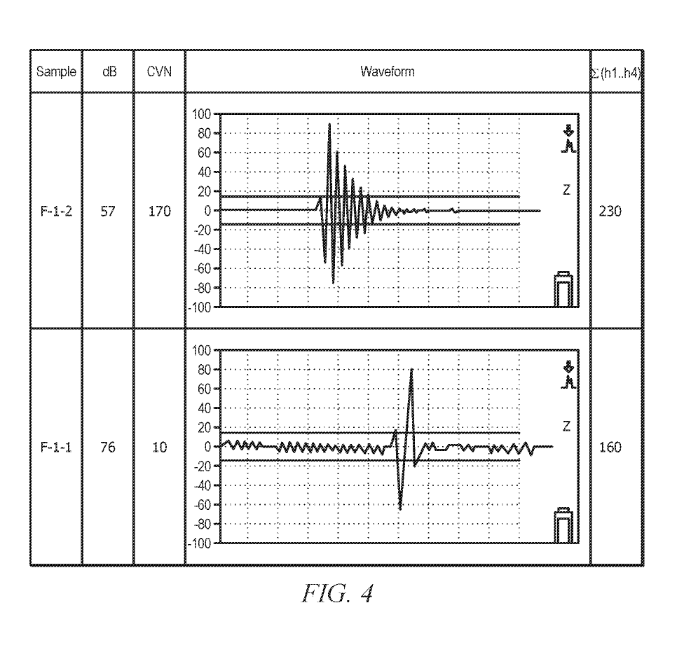

FIG. 4 illustrates a plurality of signals generated by ultrasonic testing of two different flanges, where the flanges are formed of carbon steel material.

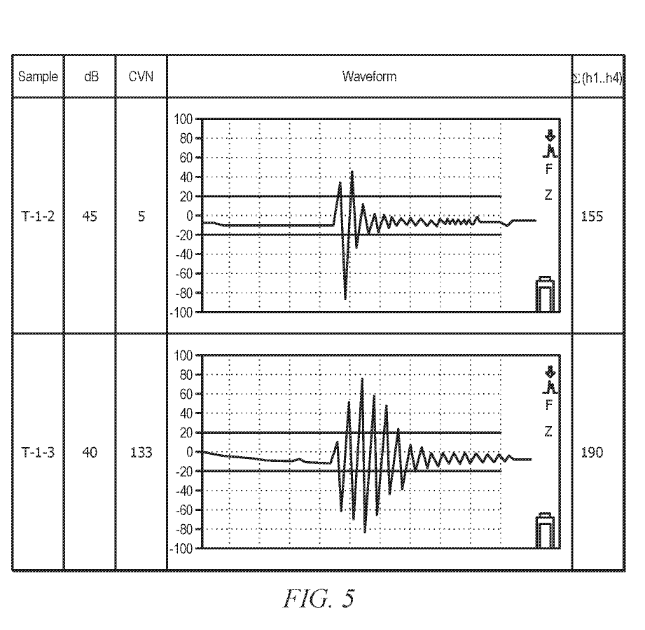

FIG. 5 illustrates a plurality of signals generated by ultrasonic testing of two different T-joints, where the T-joints are formed of carbon steel material.

When using ultrasonic techniques to test the materials, very high frequency, penetration and attenuation must be present in order to be able to properly characterize the material. The surface condition of a material should not significantly affect the results of the test. However, typical high frequency transducers naturally tend to have low penetration, and high penetration of the material may cause low attenuation. Therefore, it may be extremely difficult to accomplish all three characteristics simultaneously during the testing.

Embodiments of the disclosure include methods and devices for performing ultrasonic microscopy and providing high frequencies, adequate penetration of the material, as well as sufficient attenuation in the readings. For example, transducers coupling to the surface material may be used to achieve a proper acoustic impedance interface. The ultrasonic testing may identify grain size distributions, or texture, in three dimensions. In some embodiments a full cross section of a part may be used. The ultrasonic tests may also be performed in situ and through surface paint.

In some embodiments, detecting the texture value of a carbon steel material using ultrasonic techniques may comprise scanning the carbon steel material in a range of angles (0-180) to identify a 45 degree point between a parallel line and a perpendicular line to the rolling (or forging) direction of the material. The 45 degree point may be identified by a change in the phased array, and the significance of the change may indicate the texture value of the carbon steel material.

In a first embodiment, a method for determination of toughness of a material comprises obtaining a measure of texture within a volume of the material, wherein the obtaining is performed in a nondestructive manner; obtaining an elemental composition of the material; integrating the measure of texture and the elemental composition to generate a toughness value; and comparing the toughness value to a standard value or standard value set.

A second embodiment can include the method of the first embodiment, wherein obtaining the measure of texture comprises using ultrasonic measure of the material.

A third embodiment can include the method of the first or second embodiments, wherein the ultrasonic measure is obtained using one or more waveforms including at least one of straight beam, phased array, shear wave, and time-of-flight diffraction (TOFD).

A fourth embodiment can include the method of any of the first to third embodiments, wherein the ultrasonic measure is determined using three-dimensional ultrasonic microscopy.

A fifth embodiment can include the method of any of the first to fourth embodiments, wherein the first determination is performed by at least one of X-ray diffraction, electron backscatter diffraction, neutron diffraction, synchrotron diffraction, ultrasound examination, acoustic microscopy, and three dimensional ultrasonic microscopy.

A sixth embodiment can include the method of any of the first to fifth embodiments, wherein the volume represents a depth of at least 0.1 cm into a tested area of the material.

A seventh embodiment can include the sensor of any of the first to sixth embodiments.

An eighth embodiment can include the method of any of the first to seventh embodiments, wherein the volume represents the full thickness of a tested area of the material.

A ninth embodiment can include the method of any of the first to eighth embodiments, wherein the elemental composition represents values for at least one of the group of elements consisting of vanadium, titanium, niobium, manganese, carbon, and boron.

A tenth embodiment can include the method of any of the first to ninth embodiments, wherein the material is selected from the group consisting of metal, plastic, polymer, and composite material.

An eleventh embodiment can include the method of any of the first to tenth embodiments, wherein the metal comprises recycled material.

A twelfth embodiment can include the method of any of the first to eleventh embodiments, wherein the material comprises at least part of an extruded, rolled, wrought, forged, or pressed item.

A thirteenth embodiment can include the method of any of the first to twelfth embodiments, wherein the extruded item comprises a piping, fitting, or head of a pressure vessel.

A fourteenth embodiment can include the method of any of the first to thirteenth embodiments, wherein the rolled item comprises a plate.

A fifteenth embodiment can include the method of the any of the first to fourteenth embodiments, wherein the forged item comprises a flange.

A sixteenth embodiment can include the method of any of the first to fifteenth embodiments, wherein the elemental analysis is performed by at least one of optical emission spectroscopy, inductively coupled plasma analysis, atomic absorption analysis, X-ray fluorescence analysis, proton induced X-ray emission, and chemical analysis.

A seventeenth embodiment can include the method of any of the first to sixteenth embodiments, wherein the elemental analysis is performed on a sample of the metal generated during manufacture of item formed of the metal.

An eighteenth embodiment can include the method of any of the first to seventeenth embodiments, wherein the method is complete using an item formed of the metal in situ.

A nineteenth embodiment can include the method of any of the first to eighteenth embodiments, wherein the method is complete using an item formed of the metal while the item is in use.

In a twentieth embodiment, a system for non-destructive determination of material toughness comprises an ultrasonic testing unit, configured to generate first data related to texture within a volume of a material; an elemental analysis unit, configured to generate second data related to the elemental composition of the material; and a processor that is communicatively coupled to the ultrasonic testing unit and to the elemental analysis unit, wherein the processor is configured to combine the data to provide a toughness value.

A twenty-first embodiment can include the system of the twentieth embodiment, wherein the processor further comprises a database, the database comprising a value for a toughness standard.

A twenty-second embodiment can include the system of any of the twentieth to twenty-first embodiments, wherein the processor is further configured to compare the toughness value to the toughness standard, and to provide a toughness estimate.

A twenty-third embodiment can include the system of any of the twentieth to twenty-second embodiments, wherein the database comprises a plurality of values for a toughness standard.

A twenty-fourth embodiment can include the system of any of the twentieth to twenty-third embodiments, wherein the plurality of values represents a standard curve.

A twenty-fifth embodiment can include the system of any of the twentieth to twenty-fourth embodiments, wherein the ultrasonic testing unit generates the first data related to texture using one or more waveforms including at least one of straight beam, phased array, shear wave, and time-of-flight diffraction (TOFD).

A twenty-sixth embodiment can include the system of any of the twentieth to twenty-fifth embodiments, wherein the texture determination unit comprises at least one of an X-ray diffraction device, an electron backscatter diffraction device, a neutron diffraction device, a synchrotron diffraction device, an ultrasonic examination device, an acoustic microscope, and an ultrasonic microscope configured for three dimensional characterization.

A twenty-seventh embodiment can include the system of any of the twentieth to twenty-sixth embodiments, wherein the elemental analysis unit comprises at least one of an optical emission spectroscope, an inductively coupled plasma analyzer, an atomic absorption analyzer, an X-ray fluorescence analyzer, a proton induced X-ray emission analyzer, and a chemical analyzer.

A twenty-eighth embodiment can include the system of any of the twentieth to twenty-seventh embodiments, wherein the system is configured to characterize a finished item in situ.

A twenty-ninth embodiment can include the system of any of the twentieth to twenty-eighth embodiments, wherein the system is configured to characterize a finished item while the finished item is in use.

In a thirtieth embodiment, a method for determining a toughness value for a material of a metal part comprises detecting a texture of a carbon steel material using an ultrasonic microscopy unit, wherein the ultrasonic microscopy unit uses one or more waveforms including at least one of straight beam, phased array, shear wave, and time-of-flight diffraction (TOFD); determining elemental analysis of the carbon steel material; combining the texture with the elemental analysis to generate a toughness value for the steel; comparing the generated toughness value with a standard curve, wherein when the toughness value falls below the curve, the carbon steel material comprises an acceptable toughness, and when the toughness value falls above the curve, the carbon steel material comprises an unacceptable toughness.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for determining a toughness value for a material of a metal part, the method comprising:
detecting a texture of a carbon steel material using an ultrasonic microscopy unit, wherein the ultrasonic microscopy unit uses one or more waveforms including at least one of straight beam, phased array, shear wave, and time-of-flight diffraction (TOFD);
determining elemental analysis of the carbon steel material;
combining the texture with the elemental analysis to generate a toughness value for the steel;
comparing the generated toughness value with a standard curve, wherein when the toughness value falls below the curve, the carbon steel material comprises an acceptable toughness, and when the toughness value falls above the curve, the carbon steel material comprises an unacceptable toughness.

2. A method for determination of toughness of a material, comprising:
obtaining a measure of texture within a volume of the material, wherein the obtaining is performed in a nondestructive manner;
obtaining an elemental composition of the material;
integrating the measure of texture and the elemental composition to generate a toughness value; and
comparing the toughness value to a standard value or standard value set.

3. The method of claim 2, wherein obtaining the measure of texture comprises using ultrasonic measure of the material.

4. The method of claim 3, wherein the ultrasonic measure is obtained using one or more waveforms including at least one of straight beam, phased array, shear wave, and time-of-flight diffraction (TOFD).

5. The method of claim 2, wherein the first determination is performed by at least one of X-ray diffraction, electron backscatter diffraction, neutron diffraction, synchrotron diffraction, ultrasound examination, acoustic microscopy, and three dimensional ultrasonic microscopy.

6. The method of claim 2, wherein the volume represents a depth of at least 0.1 cm into a tested area of the material.

7. The method of claim 2, wherein the elemental composition represents values for at least one of the group of elements consisting of vanadium, titanium, niobium, manganese, carbon, and boron.

8. The method of claim 2, wherein the material comprises at least part of an extruded, rolled, wrought, forged, or pressed item.

9. The method of claim 8, wherein the extruded item comprises a piping, fitting, or head of a pressure vessel.

10. The method of claim 2, wherein the elemental analysis is performed by at least one of optical emission spectroscopy, inductively coupled plasma analysis, atomic absorption analysis, X-ray fluorescence analysis, proton induced X-ray emission, and chemical analysis.

11. The method of claim 2, wherein the method is completed using an item formed of the metal while the item is in use.

12. A system for non-destructive determination of material toughness, comprising;
an ultrasonic testing unit, configured to generate first data related to texture within a volume of a material;
an elemental analysis unit, configured to generate second data related to the elemental composition of the material; and
a processor that is communicatively coupled to the ultrasonic testing unit and to the elemental analysis unit, wherein the processor is configured to combine the data to provide a toughness value.

13. The system of claim 12, wherein the processor further comprises a database, the database comprising a value for a toughness standard, and wherein the processor is further configured to compare the toughness value to the toughness standard, and to provide a toughness estimate.

14. The system of claim 13, wherein the database comprises a plurality of values for a toughness standard.

15. The system of claim 14, wherein the plurality of values represents a standard curve.

16. The system of claim 12, wherein the ultrasonic testing unit generates the first data related to texture using one or more waveforms including at least one of straight beam, phased array, shear wave, and time-of-flight diffraction (TOFD).

17. The system of claim 12, wherein the texture determination unit comprises at least one of an X-ray diffraction device, an electron backscatter diffraction device, a neutron diffraction device, a synchrotron diffraction device, an ultrasonic examination device, an acoustic microscope, and an ultrasonic microscope configured for three dimensional characterization.

18. The system of claim 12, wherein the elemental analysis unit comprises at least one of an optical emission spectroscope, an inductively coupled plasma analyzer, an atomic absorption analyzer, an X ray fluorescence analyzer, a proton induced X-ray emission analyzer, and a chemical analyzer.

19. The system of claim 12, wherein the system is configured to characterize a finished item in situ.

20. The system of claim 12, wherein the system is configured to characterize a finished item while the finished item is in use.
